(19) United States
(12) Patent Application Publication
(10) Pub. No.: US 2026/0168455 A1
(43) Pub. Date: Jun. 18, 2026

(54) CONTROL DEVICE FOR INTERNAL COMBUSTION ENGINE

(71) Applicant: TOYOTA JIDOSHA KABUSHIKI KAISHA, Toyota-shi (JP)

(72) Inventors: Masanao IDOGAWA, Toyota-shi (JP); Tomoyuki UCHIYAMA, Toyota-shi (JP); Ryoji ABE, Toyota-shi (JP); Takafumi GOTOH, Toyota-shi (JP); Tomohiko SATOMI, Toyota-shi (JP)

(73) Assignee: TOYOTA JIDOSHA KABUSHIKI KAISHA, Toyota-shi (JP)

(21) Appl. No.: 19/366,610

(22) Filed: Oct. 23, 2025

(30) Foreign Application Priority Data
Dec. 12, 2024 (JP) 2024-217763

(51) Int. Cl. F02D 41/30; F02D 41/38

(52) U.S. Cl. CPC F02D 41/3094; F02D 41/38; F02D 2041/389; F02D 2200/501

(57) ABSTRACT

In a control device for an internal combustion engine including a port injection valve that injects fuel into an intake port and an in-cylinder injection valve that injects fuel into a cylinder, the control device is configured to execute a fuel injection using the port injection valve in a first state where a vehicle equipped with the internal combustion engine is traveling and the internal combustion engine is idling or in a second state where a stop duration of the vehicle is less than a preset threshold and the internal combustion engine is idling, and is configured to execute the fuel injection using only the in-cylinder injection valve when the internal combustion engine is in idling in a state other than the first state and the second state.

### CROSS-REFERENCE TO RELATED APPLICATION

This application is based upon and claims the benefit of priority of the prior Japanese Patent Application No. 2024-217763, filed on Dec. 12, 2024, the entire contents of which are incorporated herein by reference.

### TECHNICAL FIELD

The present disclosure relates to a control device for an internal combustion engine.

### BACKGROUND

Conventionally, an internal combustion engine including a port injection valve and an in-cylinder injection valve is known (for example, see Japanese Patent Application Publication No. 2007-321707). Japanese Patent Application Publication No. 2007-321707 proposes that fuel is injected using a port injection valve to prevent fuel adhering to an intake port or an intake valve from becoming a deposit. Specifically, Japanese Patent Application Publication No. 2007-321707 proposes to use only the in-cylinder injection valve in an idling state of the internal combustion engine.

The fuel injected from the in-cylinder injection valve is pressurized by a high-pressure pump. The high-pressure pump may be a source of noise vibration (NV). Therefore, if only the in-cylinder injection valve is used uniformly when the internal combustion engine is in an idling state as in Patent Document 1, noise and vibration might be generated due to the operation of the high-pressure pump all the time in the idling state of the internal combustion engine. As a result, NV might become a problem.

### SUMMARY

It is therefore an object of the present disclosure to provide a control device for an internal combustion engine which suppresses deterioration of NV performance while suppressing accumulation of deposits in an intake port and an intake valve.

The above object is achieved by a control device for an internal combustion engine including a port injection valve that injects fuel into an intake port and an in-cylinder injection valve that injects fuel into a cylinder, wherein the control device is configured to execute a fuel injection using the port injection valve in a first state where a vehicle equipped with the internal combustion engine is traveling and the internal combustion engine is idling or in a second state where a stop duration of the vehicle is less than a preset threshold and the internal combustion engine is idling, and is configured to execute the fuel injection using only the in-cylinder injection valve when the internal combustion engine is in idling in a state other than the first state and the second state.

The threshold may include a first threshold and a second threshold lower than the first threshold, when the control device determines whether or not the second state is established, and the control device may be configured to select the first threshold when there is no execution history of fuel injection using only the in-cylinder injection valve during one trip from the start to the stop of the internal combustion engine, and to select the second threshold when there is the execution history.

### BRIEF DESCRIPTION OF THE DRAWINGS

FIG. 1 is a schematic view illustrating a schematic configuration of an engine system to which a control device for an internal combustion engine according to an embodiment is applied;

FIG. 2 is a schematic view illustrating a schematic configuration of an internal combustion engine to which the control device for the internal combustion engine according to the embodiment is applied;

FIG. 3 is a flowchart illustrating an example of control executed by the control device for the internal combustion engine according to the embodiment; and

FIG. 4 is the flowchart illustrating the example of the control executed by the control device for the internal combustion engine according to the embodiment.

### DETAILED DESCRIPTION

Hereinafter, an embodiment of the present invention will be described with reference to the accompanying drawings. However, in the drawings, the dimensions, ratios, and the like of the respective parts may not be illustrated so as to completely match the actual ones. In addition, some drawings may be drawn with details omitted.

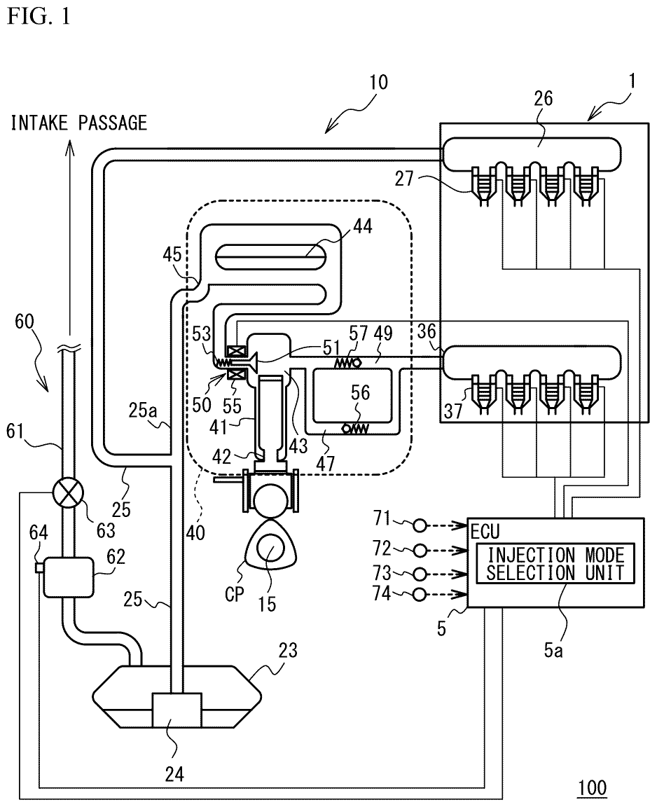

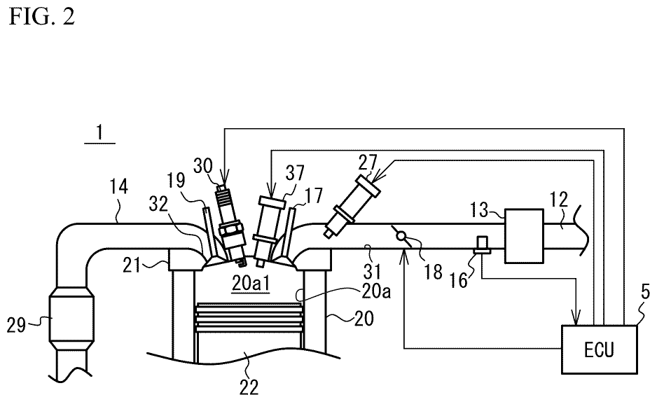

First, referring to FIGS. 1 and 2, schematic configurations of an engine system 100 to which a control device for an internal combustion engine 1 according to an embodiment is applied and the internal combustion engine 1 will be described. the internal combustion engine system 100 includes the internal combustion engine 1, a fuel supply system 10, and an electronic control unit (ECU) 5.

Referring to FIG. 2, the internal combustion engine 1 is a four stroke engine that ignites a mixture of fuel and air. The internal combustion engine 1 includes a cylinder block 20 and a cylinder head 21. In the internal combustion engine 1, the cylinder head 21 is attached to an upper side of the cylinder block 20, and a crankcase (not illustrated) is attached to a lower side of the cylinder block 20. A piston 22 is accommodated in a cylinder 20a provided in the cylinder block 20. Although only one cylinder 20a is illustrated in FIG. 2, the internal combustion engine 1 includes port injection valves 27 and in-cylinder injection valves 37 for four cylinders. That is, the internal combustion engine 1 is a four cylinder engine. However, the number of cylinders of the internal combustion engine 1 is not limited to this, and may be another number of cylinders such as three cylinders or six cylinders. Further, as the arrangement of the cylinders, a conventionally known arrangement such as an in-line arrangement or a V-type arrangement may be adopted.

The piston 22 is connected to the crankshaft via a connecting rod. The piston 22 is slidably disposed in the cylinder 20a. The cylinder block 20, the cylinder head 21, and the piston 22 define a combustion chamber 20a1.

An intake port 31 and an exhaust port 32 are connected to the cylinder head 21. An intake passage 12 is connected to the upstream side of the intake port 31. An exhaust passage 14 is connected to the downstream side of the exhaust port 32.

An air cleaner 13, an air flow meter 16, a throttle valve 18, and the port injection valve 27 are provided in the intake passage 12 in this order from the upstream side. The air cleaner 13 removes dust and the like from the air in the intake passage 12 to purify the air. The air flow meter 16 detects the flow rate of air in the intake passage 12. The throttle valve 18 adjusts the flow rate of air. The flow rate of the air increases as the opening degree of the throttle valve 18 increases. The flow rate of the air decreases as the opening degree of the throttle valve 18 decreases. The port injection valve 27 injects fuel into the intake port 31. A catalyst 29 is provided in the exhaust passage 14.

The cylinder head 21 is provided with intake valves 17, exhaust valves 19, ignition plugs 30, and in-cylinder injection valves 37. The intake valve 17 and the exhaust valve 19 are opened and closed by a valve mechanism (not illustrated). When the intake valve 17 is opened, the intake port 31 and the combustion chamber 20a1 are communicated with each other. When the exhaust valve 19 is opened, the exhaust port 32 and the combustion chamber 20a1 are communicated with each other. The ignition plug 30 generates a spark between electrodes provided at a tip end thereof, and ignites the air-fuel mixture in the combustion chamber 20a1. The in-cylinder injection valve 37 injects fuel into the combustion chamber 20a1. The internal combustion engine 1 includes a camshaft 15 (see FIG. 1) that is interlocked with a crankshaft interlocked with the piston 22 and drives the intake valve 17 or the exhaust valve 19.

The ECU 5 includes a central processing unit (CPU), a random access memory (RAM), a read only memory (ROM), a backup RAM, and other storage devices. Referring to FIG. 1, the ECU 5 includes an injection mode selection unit 5a. The injection mode selection unit 5a selects which of the port injection valves 27 and the in-cylinder injection valves 37 are to be used. The ECU 5 functions as a control device for an internal-combustion engine. The ECU 5 executes arithmetic processing and various controls based on programs and maps stored in the CPU, the ROM, and other storage devices. The RAM is a memory for temporarily storing the results of calculations by the CPU, data input from various sensors, and the like, and the backup RAM is a nonvolatile memory for storing data and the like to be saved when the internal combustion engine 1 is stopped, for example.

An accelerator opening sensor 71, a vehicle speed sensor 72, a rotational speed sensor 73, and a water temperature sensor 74 are electrically connected to the ECU 5. The accelerator opening sensor 71 detects an opening of an accelerator (not illustrated). In the present embodiment, when the detection value of the accelerator opening sensor 71 is zero, it is determined that the internal combustion engine 1 is in an idling state. The vehicle speed sensor 72 detects the speed of the vehicle on which the internal combustion engine system 100 including the internal combustion engine 1 is mounted. When the detection value of the vehicle speed sensor 72 is zero, it is determined that the vehicle is in a stopped state. The rotational speed sensor 73 detects the rotational speed Ne of the internal combustion engine. When the rotation speed Ne is lower than a predetermined rotation speed, it may be determined that the internal combustion engine 1 is in an idling state. Further, the determination as to whether or not the internal combustion engine 1 is in the idling state may be made by appropriately combining the detection value of the accelerator opening sensor 71 and the rotation speed Ne. The water temperature sensor 74 detects the temperature of the cooling water circulating in the internal combustion engine 1. Based on the detection value of the water temperature sensor 74, it is judged if the internal combustion engine 1 has finished warming up. Note that, for the warm-up completion judgment of the internal combustion engine 1, another conventionally known method may be adopted.

Referring to FIG. 1, the fuel supply system 10 includes a fuel tank 23, a low-pressure pump 24, a low-pressure pipe 25, a low-pressure delivery pipe 26, a high-pressure delivery pipe 36, a high-pressure pump 40, and a purge system 60.

The fuel tank 23 stores gasoline as fuel. The low-pressure pump 24 pressurizes the fuel and discharges the fuel to the low-pressure pipe 25. Fuel that is discharged into the low-pressure pipe 25 is supplied to the port injection valves 27 via the low-pressure delivery pipe 26, and is also supplied to the high-pressure pump 40 via a branch pipe 25a that branches off from the low-pressure pipe 25.

The high-pressure pump 40 pressurizes fuel that is supplied from the branch pipe 25a, and discharges the pressurized fuel to the high-pressure delivery pipe 36. The fuel pressurized by the high-pressure pump 40 is supplied to the in-cylinder injection valve 37 via the high-pressure delivery pipe 36.

The high-pressure pump 40 includes a cylinder 41, a plunger 42, a pressurizing chamber 43, a suction passage 45, a discharge passage 47, a relief passage 49, a suction valve 50, a discharge valve 56, and a relief valve 57.

The plunger 42 reciprocates in the cylinder 41 in conjunction with the driving of the internal combustion engine 1. Specifically, the plunger 42 is biased by a spring toward the cam CP that rotates together with the camshaft 15, and reciprocates in the cylinder 41 by the rotation of the cam CP.

The pressurizing chamber 43 is defined by the cylinder 41 and the plunger 42, and the volume of the pressurizing chamber 43 decreases as the plunger 42 rises, and the volume of the pressurizing chamber 43 increases as the plunger 42 falls.

The suction passage 45 communicates the branch pipe 25a branched from the low-pressure pipe 25 with the pressurizing chamber 43. A pulsation damper 44 is provided in the suction passage 45 to suppress fuel pressure pulsation. The relief passage 49 communicates the pressurizing chamber 43 with the high-pressure delivery pipe 36. The discharge passage 47 communicates the relief passage 49 on the pressurizing chamber 43 side of the discharge valve 56 with the relief passage 49 on the high-pressure delivery pipe 36 side of the discharge valve 56. That is, the discharge passage 47 bypasses the relief valve 57.

The suction valve 50 is a so-called spill valve, and is an electromagnetically driven on-off valve that is provided on the fuel introduction port side of the pressurizing chamber 43 and switches the communication state between the suction passage 45 and the pressurizing chamber 43. The suction valve 50 includes a valve body 51, a coil 55 that drives the valve body 51, and a spring 53 that constantly biases the valve body 51 in an opening direction. The energization of the coil 55 is controlled by the ECU 5. When the coil 55 is energized, the valve body 51 blocks the suction passage 45 and the pressurizing chamber 43 against the urging force of the spring 53. When the coil 55 is not energized, the valve body 51 is maintained in the open state by the biasing force of the spring 53.

The discharge valve 56 is a check valve that is provided on the discharge passage 47 and that allows the fuel to flow from the pressurizing chamber 43 side to the high-pressure delivery pipe 36 side but restricts the fuel from flowing in the opposite direction. Specifically, the discharge valve 56 opens when the fuel pressure in the pressurizing chamber 43 becomes higher than the fuel pressure in the high-pressure delivery pipe 36 by a predetermined amount.

In the suction stroke of the high-pressure pump 40, the suction valve 50 is opened and the plunger 42 is lowered, so that fuel from the branch pipe 25a is filled into the pressurizing chamber 43 via the suction passage 45. In the pressurizing stroke, the suction valve 50 is closed, the volume of the pressurizing chamber 43 is reduced as the plunger 42 rises, and the fuel in the pressurizing chamber 43 is pressurized. In the discharge stroke, when the force of the fuel pressure acting on the discharge valve 56 from the pressurizing chamber 43 side becomes larger than the force of the fuel pressure acting on the discharge valve 56 from the high-pressure delivery pipe 36 side and the biasing force of the spring of the discharge valve 56, the discharge valve 56 opens, and the pressurized fuel is supplied to the high-pressure delivery pipe 36.

The relief valve 57 is a check valve that is provided on the relief passage 49 and that allows the fuel to flow from the high-pressure delivery pipe 36 side to the pressurizing chamber 43 side but restricts the fuel from flowing in the opposite direction. The relief valve 57 is opened when the fuel pressure in the high-pressure delivery pipe 36 excessively rises to such an extent that an abnormality may occur in the high-pressure delivery pipe 36 or the in-cylinder injection valve 37, thereby suppressing the occurrence of an abnormality in the high-pressure delivery pipe 36 or the in-cylinder injection valve 37.

The high-pressure pump 40 generates noise and vibration as it operates, and it is conceivable that the noise and vibration affect the NV performance of the internal combustion engine 1. The configuration of the high-pressure pump 40 in the present embodiment is an example, and a high-pressure pump of another type known in the related art may be adopted.

The purge system 60 includes a purge passage 61, a canister 62, and a purge valve 63. The canister 62 is connected to the fuel tank 23 and adsorbs evaporated fuel (vapor). The purge passage 61 is connected to the canister 62 and the intake passage 12. The purge valve 63 is provided in the purge passage 61. When the purge valve 63 is opened, the fuel collected in the canister 62 is introduced into the intake passage 12 through the purge passage 61. The canister 62 is provided with a purge concentration detection unit 64 that detects the concentration of the purge fuel. The method of detecting the concentration of the purge fuel is not limited to the method using the purge concentration detection unit 64, and various conventionally known methods can be adopted. For example, the concentration of the purge fuel may be detected based on the A/F value when the purge valve 63 is opened to introduce the purge fuel into the intake passage 12.

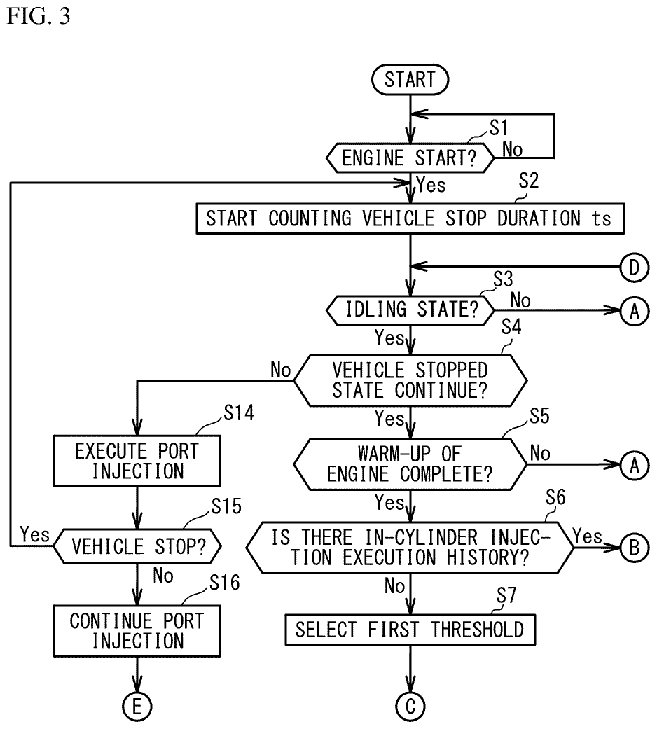

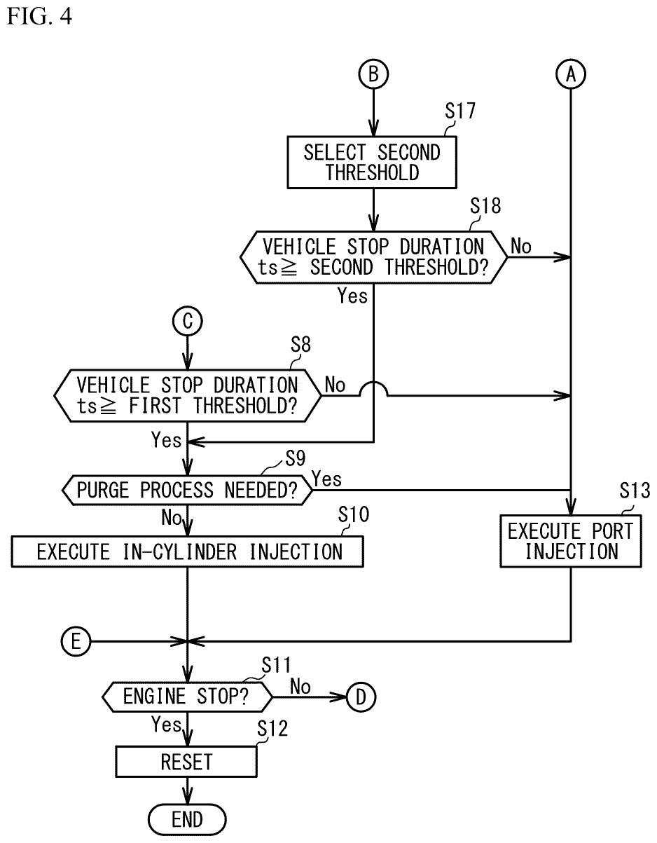

Next, an example of control performed by the ECU 5 included in the internal combustion engine system 100 and the injection mode selection unit 5a included in the ECU 5 will be described with reference to FIGS. 3 and 4. Before describing a specific control example, an outline of the control will be described first. The injection mode selection unit 5a selects the injection valves to be used in order to suppress the accumulation of deposits in the intake ports 31 and the intake valves 17 and suppress the deterioration of the NV performances in the internal combustion engine 1. Note that the accumulation of deposits may occur when the port injection valve 27 is used.

The injection mode selection unit 5a determines whether or not a first state where the vehicle equipped with the internal combustion engine 1 is traveling and the internal combustion engine 1 is in the idling state. When it is determined that the first state is established, the port injection using the port injection valve 27 is performed.

The injection mode selection unit 5a determines whether or not a second state where a vehicle stop duration ts is less than a predetermined threshold and the internal combustion engine 1 is in the idling state is established. When it is determined that the second state is established, the port injection using the port injection valve 27 is performed.

That is, in the first state and the second state, the accumulation of the deposit is less likely to occur. Therefore, in these cases, the port injection valve 27 is used. At this time, fuel injection from the in-cylinder injection valve 37 is avoided. As a result, the generation of noise and vibration accompanying the operation of the high-pressure pump 40 that supplies fuel to the in-cylinder injection valves 37 is suppressed, and deterioration of the NV performance of the internal combustion engine 1 is avoided.

On the other hand, in the idling state other than the first state and the second state, the fuel injection using only the in-cylinder injection valve 37 is executed. In the idling state other than the first state and the second state, if the port injection using the port injection valve 27 is performed, there is a concern that deposits will accumulate. Therefore, in this case, fuel injection is performed using only the in-cylinder injection valve 37, and the accumulation of deposits is suppressed.

In this way, the injection mode selection unit 5a subdivides the idle state of the internal combustion engine 1 based on the ease of accumulation of deposits, and selects an appropriate injection mode that can suppress the deterioration of the NV performances while suppressing the accumulation of deposits.

In the present embodiment, both the determination of the first state and the determination of the second state are performed, but either one of the determinations may be performed. Hereinafter, an example of the control will be described based on the flowchart illustrated in FIGS. 3 and 4.

In step S1, the injection mode selection unit 5a determines whether or not the internal combustion engine 1 starts. When the determination result in step S1 is positive (Yes), the process proceeds to step S2. On the other hand, when a negative determination (No determination) is made in step S1, the process of step S1 is repeated.

In step S2, the injection mode selection unit 5a starts counting the vehicle stop duration ts. At the time when the determination result is Yes in step S1, the counting of the vehicle stop duration ts is immediately started. After the process of step S2, the injection mode selection unit 5a proceeds to step S3.

In step S3, the injection mode selection unit 5a determines whether or not the internal combustion engine 1 is idling. This determination is performed because the idling state may be a condition for the accumulation of deposits, and the operation of the high-pressure pump 40 in the idling state is likely to affect the NV performance. In the present embodiment, the injection mode selection unit 5a determines that the internal combustion engine 1 is idling when the detection value of the accelerator opening sensor 71 is zero. That is, the determination is Yes. When the determination result in step S3 is Yes, the process proceeds to step S4. On the other hand, when the determination result is No in step S3, the process proceeds to step S13.

In step S4, the injection mode selection unit 5a determines whether or not the stopped state of the vehicle is continued. This determination is made because it is considered that the manner of accumulation of deposits differs depending on whether the vehicle is traveling or stopped. This is also because it is considered that there is a difference in the influence on the NV performance due to the operation of the high-pressure pump 40. In the present embodiment, the injection mode selection unit 5a determines that the stopped state of the vehicle is continued when the detection value of the vehicle speed sensor 72 is zero. That is, the determination is Yes. When the determination result in step S4 is Yes, the process proceeds to step S5. On the other hand, when the determination result is No in step S4, the process proceeds to step S14. Note that a case where the determination result in step S4 is No corresponds to the first state.

In step S5, the injection mode selection unit 5a determines whether or not the warm-up of the internal combustion engine 1 is completed. This determination is made because it is considered that the way of accumulation of deposits differs depending on the warm-up state of the internal combustion engine 1. Specifically, in a state where the warm-up of the internal combustion engine 1 is not completed, the deposit is less likely to accumulate. In a state where the warm-up of the internal combustion engine 1 is completed, the deposit is likely to accumulate. In the present embodiment, the injection mode selection unit 5a determines that the internal combustion engine 1 has been warmed up when the detection value of the water temperature sensor 74 is higher than a predetermined threshold for warm-up determination. That is, the determination is Yes. When the determination result in step S5 is Yes, the process proceeds to step S6. On the other hand, when the determination result is No in step S5, the process proceeds to step S13.

In step S6, the injection mode selection unit 5a determines whether or not there is a history of execution of in-cylinder injection. The history of the execution of the in-cylinder injection is a history of whether or not the in-cylinder injection is executed in step S10 described later. Here, when it is determined that the internal combustion engine 1 is stopped in step S11, which will be described later, the history is reset in step S12. Therefore, the history is a history during one trip from the start to the stop of the internal combustion engine 1. This determination is made to change the threshold for the vehicle stop duration ts based on the history of execution of the in-cylinder injection. When the determination result in step S6 is No, the process proceeds to step S7. On the other hand, when the determination result in step S6 is Yes, the process proceeds to step S17. In step S7, a first threshold is selected. In step S17, a second threshold is selected.

Both the first threshold and the second threshold are included in the threshold for the vehicle stop duration ts of the vehicle. The second threshold is lower (shorter) than the first threshold. First, the reason why the threshold for the vehicle stop duration ts is provided will be described.

In a vehicle that is stopped, when the internal combustion engine 1 is in an idling state, it is considered that the accumulation of deposits is likely to occur. However, on the other hand, if the in-cylinder injection using the in-cylinder injection valve 37 is performed uniformly in order to avoid the accumulation of the deposit, the NV performance may be deteriorated. Therefore, in the idle state in which the vehicle stop duration ts is short, the port injection using the port injection valve 27 is permitted, and in the idle state in which the vehicle stop duration ts is long, the cylinder injection using the in-cylinder injection valve 37 is performed. This makes it possible to achieve both suppression of accumulation of deposits and suppression of deterioration of NV performance.

Next, the first threshold and the second threshold will be described. When the in-cylinder injection in step S10 is not executed during one trip from the start to the stop of the internal combustion engine 1, the first threshold is selected. When the in-cylinder injection in step S10 is executed during one trip from the start to the stop of the internal combustion engine 1, the second threshold is selected. That is, when the second threshold is selected, the in-cylinder injection using the in-cylinder injection valve 37 is performed before the second threshold is selected. Therefore, it is considered that the occupant of the vehicle experiences the sound and the vibration accompanying the operation of the high-pressure pump 40 and is accustomed to the state where the high-pressure pump 40 is operating. In such a case, the second threshold is selected so as to place importance on the suppression of the accumulation of deposits and to shift to the in-cylinder injection using the in-cylinder injection valve 37 earlier.

After the process of step S7, the injection mode selection unit 5a proceeds to step S8. After the process of step S17, the injection mode selection unit 5a proceeds to step S18.

In step S8, the injection mode selection unit 5a determines whether or not the vehicle stop duration ts is equal to greater than the first threshold. When the determination result in step S8 is Yes, the process proceeds to step S9. On the other hand, when the determination result is No in step S8, the process proceeds to step S13. Note that a case where the determination result in step S8 is No corresponds to the second state.

In step S9, the ECU 5 determines whether or not the purge process in the purge system 60 is needed. For example, the ECU 5 determines whether the purge concentration detected by the purge concentration detection unit 64 is lower than a predetermined threshold. The reason for this determination is that, if the in-cylinder injection using the in-cylinder injection valve 37 is performed when the purge process is needed, the injection amount may conflict with the minimum injection amount of the in-cylinder injection valve 37. That is, the injection amount of the in-cylinder injection valve 37 decreases by performing the purge process, but this may conflict with the minimum injection amount of the in-cylinder injection valve 37. As a result, it is assumed that the injection amount of the in-cylinder injection valve 37 cannot be appropriately controlled. By making this determination, it is possible to realize a request for the purge process and an appropriate fuel injection amount. When the determination result in step S9 is No, the process proceeds to step S10. On the other hand, when the determination result is Yes in step S9, the process proceeds to step S13.

In step S10, the injection mode selection unit 5a selects the in-cylinder injection valves 37 and executes in-cylinder injection. This makes it possible to suppress the accumulation of deposits. After the process of step S10, the injection mode selection unit 5a proceeds to step S11.

In step S11, the injection mode selection unit 5a determines whether or not the internal combustion engine 1 stops. When the determination result is Yes in step S11, the process proceeds to step S12. On the other hand, when the determination is No in step S11, the process from step S3 is repeated.

In step S12, the injection mode selection unit 5a resets the history in the trip. Thus, when the internal combustion engine 1 is started next time, the processing after step S1 is newly performed.

Next, step S13 will be described. In step S13, the injection mode selection unit 5a executes port injection using the port injection valves 27. When the determination is No in step S3, step S5, step S8, and the determination is Yes in step S9, the process of step S13 is executed. In addition, the process of step S13 is also executed in a case where a No determination is made in step S18 described later. In step S13, the port injection using the port injection valves 27 is executed, so that the deterioration of the NV performances is suppressed.

The process of step S13 is executed when the determination result of step S3 is No because it is considered that deposits are unlikely to accumulate when the internal combustion engine 1 is not idling. When the process of step S13 is executed due to the determination of No in step S1, the in-cylinder injection using the in-cylinder injection valves 37 may be used in combination depending on the state of the internal combustion engine 1. This is because it is considered that the operating noise of the high-pressure pump 40 and the like are not so annoying to the occupant of the vehicle when the internal combustion engine 1 is not in the idling state.

Further, the reason why the process of step S13 is executed when the determination result of step S5 is No is that it is considered that deposits are unlikely to accumulate when the warm-up of the internal combustion engine 1 is not completed.

Further, the reason why the process of step S13 is executed when the determination result of step S8 is No and when the determination result of step S18 is No is that it is considered that deposits are unlikely to be deposited in the vehicle that is stopped when the internal combustion engine 1 is idling and the vehicle stop duration ts is short.

After the process of step S13, the injection mode selection unit 5a proceeds to step S11. The processing after step S11 is the same as that after step S10, and thus the detailed description thereof will be omitted here.

Next, step S14 will be described. In step S14, the injection mode selection unit 5a executes port injection using the port injection valves 27 in the same manner as in step S13. The process of step S14 is executed when the determination result of step S4 is No, that is, when the vehicle is traveling. When the vehicle is traveling, even if the internal combustion engine 1 is idling, the flow of air in the intake passage 12 is considered to be faster than when the vehicle is stopped and idling. Therefore, it is considered that the accumulation of the deposit is unlikely to occur. Therefore, the port injection using the port injection valve 27 is permitted and performed. When step S14 process is executed, the in-cylinder injection using the in-cylinder injection valves 37 may be performed in accordance with the state of the internal combustion engine 1 and the vehicle speed. For example, when the vehicle speed is high, it is conceivable that the operating noise of the high-pressure pump 40 is not so annoying, and in such a case, the in-cylinder injection may be used in combination. Of course, when the in-cylinder injection valve 37 is not used, the deterioration of the NV performance due to the operation of the high-pressure pump 40 is suppressed. After the process of step S14, the injection mode selection unit 5a proceeds to step S15.

In step S15, the injection mode selection unit 5a determines whether or not the internal combustion engine 1 is stopped. This determination is made because the injection mode needs to be selected again when the vehicle stops. When the determination is Yes in step S15, the process from step S2 is repeated. That is, after the vehicle stops, the counting of the vehicle stop duration ts is started again, and the subsequent processing is performed. On the other hand, when the determination result of Step S15 is No, the port injection using the port injection valves 27 is continued in step S16. After the process of step S16, the injection mode selection unit 5a proceeds to step S11. The processing after step S11 is the same as that after step S10, and thus the detailed description thereof will be omitted here.

Next, step S17 and step S18 will be described. After the second threshold is selected in step S17, the injection mode selection unit 5a determines whether or not the vehicle stop duration ts is equal to or longer than the second threshold in step S18. When the determination result in step S18 is Yes, the process proceeds to step S9. On the other hand, when the determination result is No in step S18, the process proceeds to step S13. Note that a case where the determination result in step S18 is No corresponds to the second state. Step S9 and step S13 are as described above, and thus detailed description thereof will be omitted here.

In the present embodiment, as illustrated in the flowchart of FIGS. 3 and 4, many determination steps are included. Among these, a case where the determination result is Yes in step S3 and the determination result is No in step S4 corresponds to the first state. Further, the case where the determination is Yes in step S3 and the determination is No in step S8 corresponds to the second state. A case where the determination result is Yes in step S3 and the determination result is No in step S18 also corresponds to the second state.

In another embodiment, at least one of the determination of the first state and the determination of the second state may be included. That is, it is possible to adopt a mode in which only the determination of the first state is adopted, or a mode in which only the determination of the second state is adopted. Further, the determination of the first state, the determination of the second state, and other determinations, for example, the determination of step S5 and the determination of step S9 may be appropriately combined.

According to the present embodiment, when the internal combustion engine 1 is in the first state or the second state, the port injection using the port injection valve 27 is performed. Therefore, it is possible to suppress deterioration of the NV performance. When the internal combustion engine 1 is in an idling state other than the first state and the second state, the in-cylinder injection using only the in-cylinder injection valve 37 is performed. This makes it possible to suppress the accumulation of deposits.

According to the present embodiment, by appropriately selecting the first threshold and the second threshold, the accumulation of deposits is suppressed, and the deterioration of the NV performance is suppressed.

Although some embodiments of the present disclosure have been described in detail, the present disclosure is not limited to the specific embodiments but may be varied or changed within the scope of the present disclosure as claimed.

What is claimed is:

1. A control device for an internal combustion engine including a port injection valve that injects fuel into an intake port and an in-cylinder injection valve that injects fuel into a cylinder,
wherein the control device is configured to execute a fuel injection using the port injection valve in a first state where a vehicle equipped with the internal combustion engine is traveling and the internal combustion engine is idling or in a second state where a stop duration of the vehicle is less than a preset threshold and the internal combustion engine is idling, and is configured to execute the fuel injection using only the in-cylinder injection valve when the internal combustion engine is in idling in a state other than the first state and the second state.

2. The control device for the internal combustion engine according to claim 1, wherein
the threshold includes a first threshold and a second threshold lower than the first threshold, when the control device determines whether or not the second state is established, and
the control device is configured to select the first threshold when there is no execution history of fuel injection using only the in-cylinder injection valve during one trip from the start to the stop of the internal combustion engine, and to select the second threshold when there is the execution history.
